(19) United States
(12) Patent Application Publication
(10) Pub. No.: US 2010/0038857 A1
(43) Pub. Date: Feb. 18, 2010

(54) Method of creating a uniform bead of sealing, adhering material or caulking in a corner or between two surfaces that are parallel at one axis, angle or edge or more

(76) Inventor: Michael Fredrick Renkert, Denver, CO (US)

Correspondence Address: JACKSON ESQUIRE;ROGER A. JACKSON, 209 KALAMATH STREET, UNIT 9, DENVER, CO, 80223-1348, US

(21) Appl. No.: 12/313,084

(22) Filed: Nov. 17, 2008

Related U.S. Application Data
(60) Provisional application No. 61/003,776, filed on Nov. 20, 2007.

(51) Int. Cl. F16J 15/02

(52) U.S. Cl. 277/312; 277/630

(57) ABSTRACT

The present invention relates to the forming, molding and finishing of caulking material between two surfaces or in a corner. The present invention utilizes the geometrical properties of a ball-shaped forming tool, the length of its radius and a related gauged dispensing mechanism to create uniform, functional beads of caulking between such surfaces.

### BACKGROUND OF THE INVENTION

1. Field of the Invention

The present invention relates to a method of smoothing, forming and finishing caulking or similar compounds or other materials that are applied onto or between physical surfaces while pliable, plastic, viscous or wet but then harden to form an adhering barrier on or between said surfaces for the purpose of sealing, filling or reforming any void between the surfaces.

The construction field is a common context in which such sealing and adhering materials of above description are used. Often such adhering, sealing material is used in the construction of bathrooms and kitchens but is not limited to such applications. A similar instance of a need to seal and fill between two surfaces is in the case of “chinking” between the surfaces of logs on a log cabin. Just as caulking is applied as a wet, viscous material, so is the sealant used to fill the gaps between logs in a cabin. Another example is sealing a gap around a window, a door frame or a skylight. As long as two surfaces that are generally parallel have a space between them that needs to be sealed, a viscous adherent can be used to seal the gap between them.

2. Description of Related Art

Many caulking tools have been designed for the purpose of smoothing or finishing rough caulking or similar material beads after such material has been applied to surfaces requiring such material, which typically consist of corners but sometimes include surfaces of other shapes or just voids that one would want to be filled. Typically, caulking tools consist of a wedge, spoon or related angled shape on the end of a handle or applicator that can fit into a corner. They are made of plastic, rubber or other materials, and they all attempt to perform the act of smoothing and removing excess caulking in the same general manner for the purpose of creating a uniformly shaped finished bead that is visually pleasing and as well as effective as a barrier against anything that can cause damage or is simply not desired to be present in a void or crack. By placing the intended smoothing or finishing head of a typical caulking tool in a corner or area that has a rough caulking or similar bead present, the rough bead is smoothed and spread more evenly by dragging the caulking tool, guided by the walls intersecting at the corner where the rough caulking tool has been applied.

There are flaws in previously designed caulking tools. One is that they can allow for a finished caulking bead of variable volume, consistency and thickness. This inconsistent finish is achieved by irregular motion of the hand that moves the tool from more than one orientation. The flat or curved head of a tool can be oriented in a corner at more than one angle, and as the hand holding the tool shakes or changes position, so does the angle of the tool. An example of this would be a triangle with rounded corners that do not touch the axis of the corner while it touches both surfaces perpendicularly. If the tool is moved to a 45-degree angle, its tip is farther from the axis than when it was oriented perpendicularly to each surface. If the same tool held at a 30-degree angle, the tip of the tool, which is intended to do most of the finishing effect, is even farther from the axis of the surfaces. Thus, as the orientation and angle of the tool changes as it is dragged over a rough caulking bead, so does the thickness and volume of the finished caulking bead. Another problem with the typical caulking tool utilizing a wedge, spoon or related angled shape is the fact that the tip of the tool can actually get closer to the axis of two surfaces through the act of twisting the tool. As the tool turns and becomes closer to parallel to the surfaces, its tip goes closer to the axis. This allows for more caulking or similar material to be removed than desired. Another problem with existing manual caulking tools is what is referred to here as “plow effect”. As the tool is dragged over the roughly applied caulking material in attempt to smooth it out, excess caulking that comes in contact with the caulking tool is scraped up and pushed along much like snow in front of a snow plow. This often has the effect of spreading caulking wider than desired or into bumps and cracks beyond the surface area that was intended to receive the caulking material. Another flaw with previously designed caulking tools is the fact that there is no easy way to clean up caulking material that has been “plowed” beyond the area desired to receive the caulk. It must be wiped or washed or scraped, and as a particularly sticky material, this is a difficult, time-consuming process that often allows the opportunity to disturb the previously finished caulking bead.

In the case of a rag, finger, sponge, rubber or similar soft applicator, these tools can be oriented variably and pushed deeper or shallower into the corner than desired by varying force, having the effect of smearing or digging out too much or leaving behind more caulking material than desired. This results from different amounts force being applied to the finishing tool.

Stopping any previously designed caulking or similar finishing tool at a location along the rough bead from moving creates the difficult situation of having to reorient the tool at the same depth and angle, or the next area of the bead will not be finished in the same manner as the bead finished before stopping.

Another problem with current tools is that when caulking around a bend, such as in the corner between two shower walls or around a round sink, the orientation of current caulking finish tools must remain consistently oriented to the axis for the entire distance around such a curve, or the consistency of the bead can be disturbed.

### SUMMARY OF THE INVENTION

The present invention relates to an improved method of finishing a rough bead of caulking or related materials after it has been applied to an area requiring such treatment. Caulking and other materials that are applied in a wet or viscous form for the purpose of creating a barrier and aesthetic effect have interior and exterior applications. Interior applications include use as a barrier between corners of various sizes and angles, gaps between walls and fixtures, surfaces, features, fixtures, walls, floors and walls, cracks or generally any two surfaces that intersect or come close to each other, that create a crack or void between them needs to be filled and protected. Exterior applications include corners, gaps between surfaces such as logs, (used as a “chinking” tool for log cabins and similar structures,) staircases, cracks, windows, skylights, etc., or any surfaces or features that intersect or come close to each other and create a crack or void that needs to be filled or protected. Similar applications might utilize other materials such as grouting, spackle, paint, glue, foam, cement and other compounds that are applied as a barrier or aesthetic effect between two surfaces.

A freshly applied bead or volume of caulking or other similar adhesive, material that is applied as a barrier or adherent is often squeezed out or applied by hand at an inconsistent rate and volume leaving a roughly shaped volume of such material and often not entirely on the location that is intended to receive it. Thus a “finishing” tool can be used to smooth out and reform the rough mass of applied material while forcing the applied material in the area that is intended to receive it.

The present invention captures and utilizes the physical relationship that exists between a ball with a specific radius and the infinite contact points it creates when it touches and slides or rolls on two surfaces that are generally parallel at at least one axis, angle or edge. The characteristics of this geometrical arrangement are beneficial as the mathematical basis of a set of tools used for finishing, manipulating or forming a freshly applied bead of caulking or other viscous, plastic, pliable or wet materials used for creating an adhering barrier on and or between said surfaces.

The invention described introduces a spherical or ball-shaped tool with a handle or other method of manipulating it as a finisher of a rough or wet caulking bead or other material applied for the purpose of creating said barrier.

The invention is used in coordination with a gauged dispensing mechanism that applies a ribbon, tape or similar material onto and parallel to the line established by said contact points on the surfaces for the purpose of creating an edge impermeable by the applied material.

The invention provides a method and mechanism for applying tape or ribbon in a calculated, desired location which is determined by the radius of the ball and the contact points it creates when touching both of said surfaces. The tape or similar material is dispensed by a mechanism that has a mathematical relationship with the size of finished bead desired and thus the size of finishing tool radius that is used which establishes the location to which the adhesive tape needs to be applied. Though the sizes of the finished bead, finishing tool and tape location can be of any dimensions, the relationship between them is always relatively specific. The size of the desired finished bead determines which spherical smoothing tool is used, and the radius of that spherical smoothing tool head determines where a line of tape must be applied as a barrier to excess material.

Often caulking or similar materials are applied to surfaces to provide a visual effect or barrier when a void exists between two such surfaces. Most often, caulking or related materials are applied between two surfaces that oppose each other at approximately ninety degrees.

Additionally, the invention relates to a method of applying adhesive tape or other similar material to such surfaces, so as to set a barrier that does not permit caulking or similar material to adhere to surfaces where not desired and to allow easy removal of excess applied material.

The method comprises:
1. A set of tools with spherical heads inherently containing an assortment of radii and a method of holding them.
2. A dispensing tool with a mechanism that allows tape or ribbon to be dispensed on a parallel line a specific distances from the axis of said surfaces. These specific distances correlate to and are the same as the radii of the spherical finishing tool heads supplied in the present invention.

### BRIEF DESCRIPTION OF THE DRAWINGS

FIGS. 1A and 1B show a ball of a specific radius “A” oriented in a corner. Despite rotation, the contact points of the ball on the surfaces remain consistent for a ball with a radius of this size “A”.

FIGS. 2A and 2B show ball of a different specific radius “B” oriented in a corner. Despite rotation, the contact points of the ball on the surfaces remain consistent for a ball with a radius of this size “B”.

FIGS. 3A and 3B show a ball of a different specific radius “R” oriented in a corner. Despite rotation, the contact points of the ball on the surfaces remain consistent for a ball with a radius of this size “R” and the space beneath the ball and between the contact points remain the same.

FIG. 4 shows a ball of a radius “R” oriented in a corner. As the ball moves parallel to the surfaces while touching both, contact lines are established by infinite contact points and the space beneath the ball between the contact lines remain consistent.

FIG. 5 shows a ball oriented in a corner. Despite the fact that points on the corner are not in a straight line, the ball creates contact points on the surfaces that remain a consistent distance from the axis of the two surfaces.

FIGS. 6A and 6B show that when a ball of a specific radius oriented so that it touches two surfaces that are generally parallel at one edge, it will form any viscous material to fit the space under the ball and between the contact points, and any excess material that does not fit under the ball will be displaced outside of the contact points.

FIG. 7 shows that a ball of a specific radius introduced to two surfaces forming a corner will displace any excess viscous material that does not fit under the ball, and as the ball moves parallel to both surfaces touching both, it will leave a consistently shaped trail or bead of the material behind it with all excess left in a trail outside of the lines of contact points.

FIGS. 8A and 8B shows that if a strip of tape is applied with the closer edge to the corner lying on the line of contact points, the material that does not form the trail or bead behind the ball will be displaced onto the tape.

FIG. 8C is a larger view of the contact points with the edge of the tape applied to it.

FIG. 9 shows that the excess material that is displaced outside of the lines of contact points will be displaced onto the tape.

FIG. 10 shows that when the tape with the excess viscous material is removed, what is left is an evenly formed, consistent bead of material formed in the corner between the two surfaces.

FIG. 11 shows a set of ball-tools with specific radii and handles.

FIG. 12A is a side view of FIG. 12B.

FIG. 12B shows one possible gauged mechanism in section that can dispense tape a specific distance from the corner of two surfaces.

FIG. 13 shows another possible gauged mechanism that can dispense tape a specific distance from the corner of two surfaces.

FIG. 14A shows another possible gauged mechanism that can dispense tape a specific distance from the corner of two surfaces.

FIG. 14B shows a larger view of a portion of FIG. 14A.

FIG. 15 shows another possible gauged mechanism that can dispense tape a specific distance from the corner of two surfaces.

FIGS. 16A and 16B show other possible gauging mechanisms that could be used to place tape a specific distance from a corner in a mechanism intended to do so.

FIG. 17A shows a top view of FIG. 17B.

FIG. 17B shows another possible gauged mechanism that can dispense tape a specific distance from the corner of two surfaces.

### DESCRIPTION OF THE PREFERRED EMBODIMENT

The preferred embodiment of the tool is one that utilizes the relationship between the contact points of a ball as a forming tool of a certain size or multiplicity of sizes touching two surfaces that are relatively parallel at least one angle, axis or edge and a mechanism that can apply tape parallel and collinearly to a line of those contact points on both sides of the real or projected intersection of such surfaces for the purpose of forming and smoothing a caulking or other type of sealing, adhering bead.

This relationship can be demonstrated as follows:

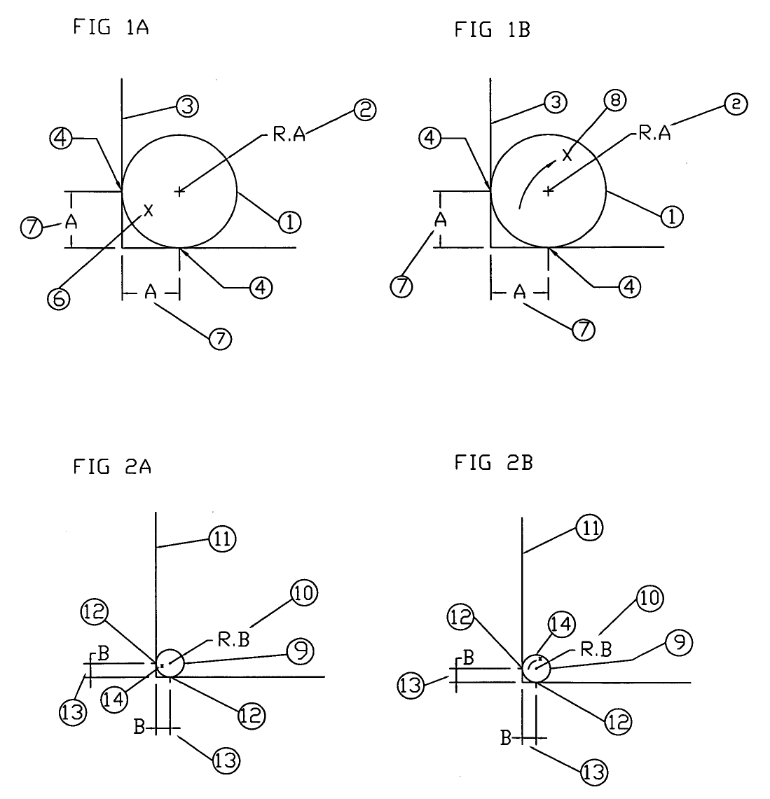

A ball (FIG. 1A-1) or a specific radius A (FIG. 1A-2) oriented in a corner between two generally perpendicular surfaces (FIG. 1A-3) while touching both establishes contact points (FIG. 1A-4) that are equally distant from the axis of the surfaces (FIG. 1A-6) and thus equal to the radius of the ball that establishes the contact points.

A point “X” (FIG. 1A-7) on the ball demonstrates rotation of the ball. While the ball remains in contact with the surfaces as described above, the contact points remain consistent despite the movement of point “X” to a different location (FIG. 1B-8).

A ball (FIG. 2A-9) of a different specific radius (FIG. 2A-10) oriented in a corner (FIG. 2A-11) between two generally perpendicular surfaces while touching both establishes contact points (FIG. 2A-12) that are equally distant from the axis of the surfaces (FIG. 2A-13) and thus equal to the radius of the ball that establishes the contact points.

A point “X” (FIG. 2A-14) on the ball demonstrates rotation of the ball. While the ball remains in contact with the surfaces as described above, the contact points remain consistent despite the movement of point “X” to a different location (FIG. 2B-14).

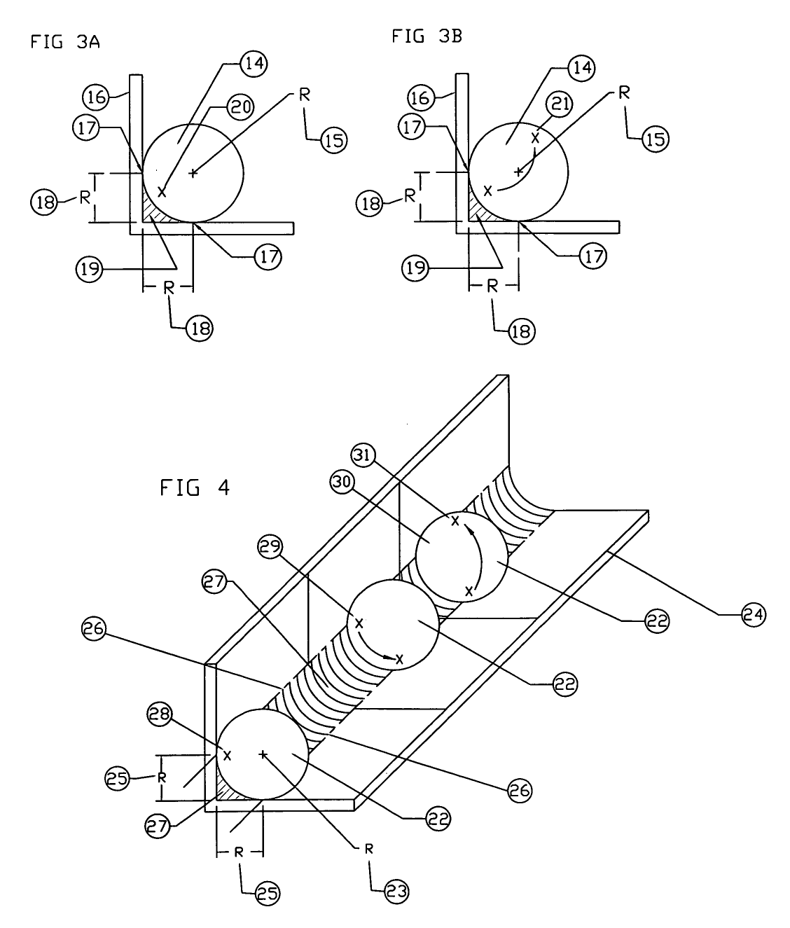

A ball of a specific radius “R” (FIG. 3A-15) as oriented in a corner (FIG. 3A-16) establishes contact points (FIG. 3A-17) a distance from the axis of the surfaces equal to the radius of the ball (FIG. 3A-18) as described above. The ball oriented as described inherently forms a space beneath it and between the contact points (FIG. 3A-19) that remains consistent despite the rotation of the ball depicted by point “X” (FIG. 3A-20) moving to point “X” (FIG. 3b-21.)

A ball (FIG. 4-22) of a specific radius “R” (FIG. 4-23) oriented in a corner as described above (FIG. 4-24) establishes contact points (FIG. 4-25) on the surfaces that are an equal distance from the axis of the surfaces, which are equal to the radius of the ball. Two lines of contact points (FIG. 4-26) are thus established on the surfaces and a 3-dimensional space or volume (FIG. 4-27) is established under the ball and between the contact lines as the ball moves parallel to while touching both surfaces, depicted by the same ball (FIG. 4-22) moving from a position (FIG. 4-28) to another position along the contact lines (FIG. 4-29) to a third position along the contact lines (FIG. 4-30). The contact lines and the space established below the ball between the lines as described above remain consistent despite this movement along the contact lines, and despite the rotation of point “X” shown on the ball. (FIG. 4-31).

A ball (FIG. 5-32) of a specific radius (FIG. 5-33) oriented between two surfaces (FIG. 5-34) as described above establishes contact points on the surfaces (FIG. 5-35) and thus infinite contact points establishing lines (FIG. 5-36) as described above despite the fact that the edges of the surfaces are not parallel. The relationship of the radius of the ball being equal to the distance of the contact points on surfaces described as above and thus contact lines remains consistent because at any specific location (FIG. 5-37), (FIG. 5-38), (FIG. 5-39) there are only two specific contact points. It is the accumulation of these points that creates the lines.

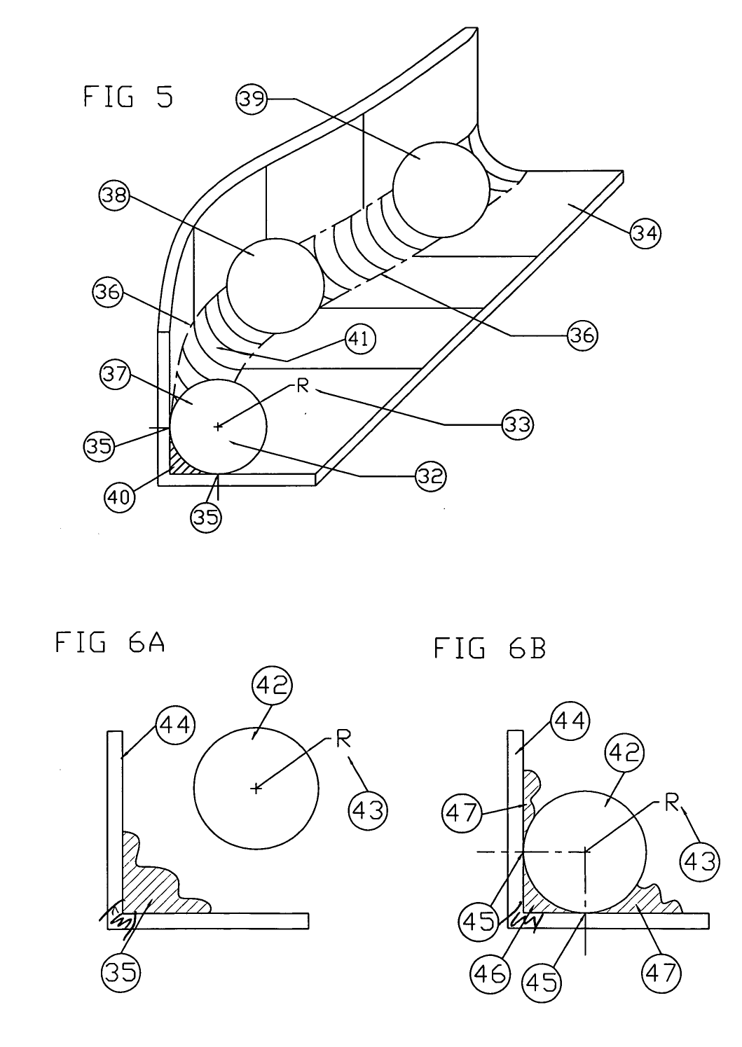

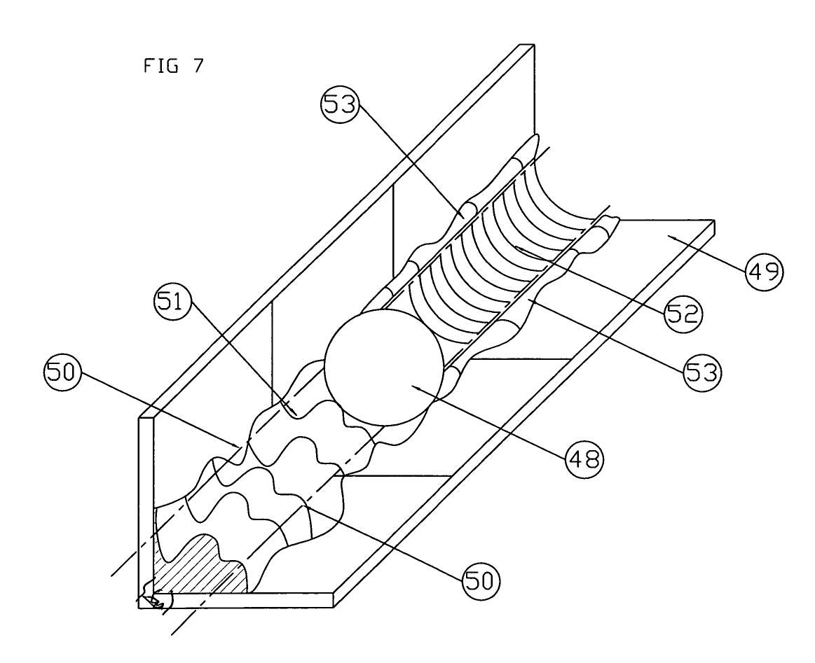

A ball (FIG. 6A-42) of a specific radius “R” (FIG. 6A-43) oriented between two surfaces that establish a corner as described above (FIG. 6A-44) will establish contact points (FIG. 6A-45) as described above. If a viscous mass is present at the vertex of the surfaces (FIG. 6A-46), a specific amount equal to the space below the ball and between the contact points will remain and fill any void between the surfaces while any excess will be forced outside of that space and outside of the contact lines (FIG. 6B-47).

A ball (FIG. 7-48) touching two surfaces that form a corner as described above (FIG. 7-49) establishes contact lines as described above (FIG. 7-50). When the ball moves along the surfaces touching both contact lines, any viscous material present in the corner (FIG. 7-51) will be formed into the shape of the space beneath the ball and between the contact points as described above (FIG. 7-52), will fill any void between the surfaces and any excess viscous material will be displaced outside the contact lines (FIG. 7-53).

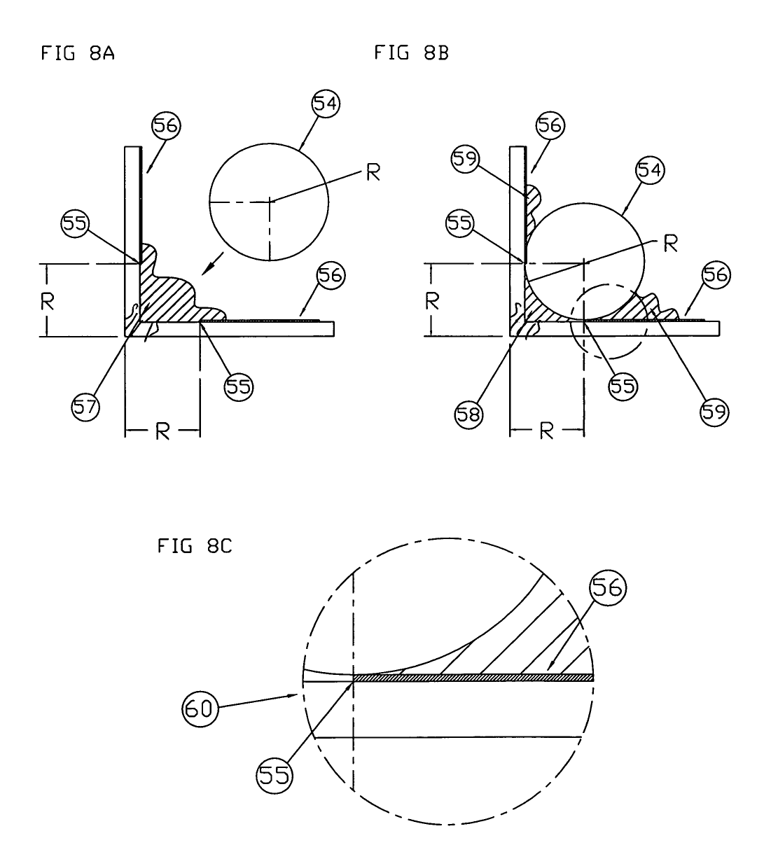

A ball (FIG. 8A-54) establishes contact points (FIG. 8A-55) on surfaces as described above. When the inner edge of tape or a similar material is dispensed onto and parallel to the contact lines (FIG. 8A-56), and the ball is moved through the viscous material as described above (FIG. 8A-57) it can establish a barrier between the surface and the excess displaced material. The space between the ball and the corner will be filled as described above (FIG. 8B-58) and the excess material will be displaced onto the tape (FIG. 8B-59). An enlarged view of the tape lying on the contact points is seen below (FIG. 8C-60)/(FIG. 8C-55).

A ball (FIG. 9-61) moving along contact lines through viscous material in a corner as described above (FIG. 9-62) will displace excess material (FIG. 9-63) onto tape (FIG. 9-64) and leave behind a uniform trail or bead of the viscous material (FIG. 9-65) as described above.

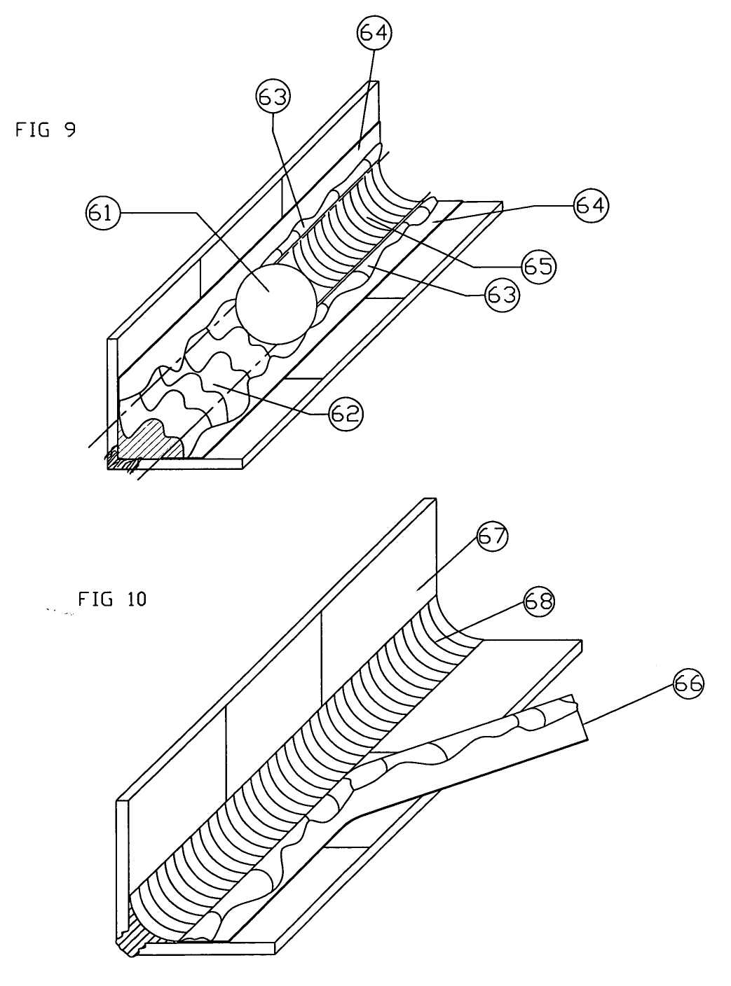

The tape which holds the excess viscous material (FIG. 10-66) can be removed leaving behind a clean surface (FIG. 10-67) and a uniform bead of the viscous material adhered to the corner (FIG. 10-68) and filling any void that exists between the surfaces.

The tools used to shape or form the applied viscous material consist of a spherical head of any specific radii (FIG. 11-69) and a handle (FIG. 11-70) for holding and manipulating the spherical head.

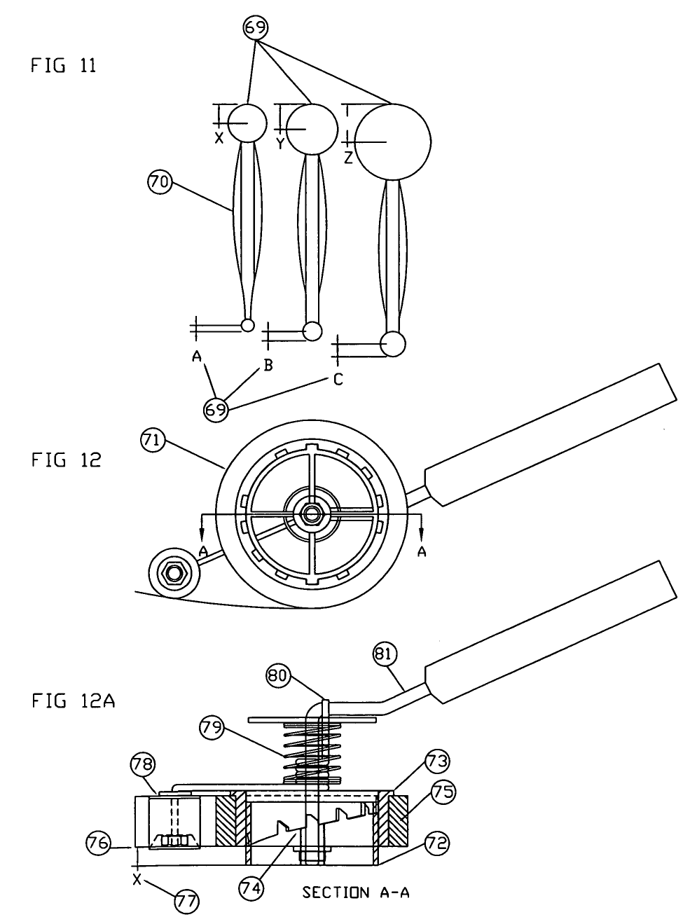

One possible mechanism that could be used to apply tape to a line of contact points as described above is shown in side-view (FIG. 12A-71) with section line A-A.

The same tool is shown in section (FIG. 12-B). This tool consists of a drum (FIG. 12B-72) that fits into a sleeve (FIG. 12B-73). The drum and sleeve have a gauged set of grooves and teeth (FIG. 12B-74) that fit congruously. A roll of tape (FIG. 12B-75) is mounted on the sleeve. The set of teeth and grooves in the drum and sleeve allow the roll of tape and thus the edge of the tape (FIG. 12B-76) to be set at a desired distance (FIG. 12B-77) from a surface as described above. The tape is rolled out and pressed to the surface by a smaller drum (FIG. 12B-78). A spring is used to tension the drum and sleeve (FIG. 12B-79). The smaller drum is held to the mechanism by a bent and rolled wire (FIG. 12B-80). The entire mechanism can be held and controlled by a handle (FIG. 12B-81).

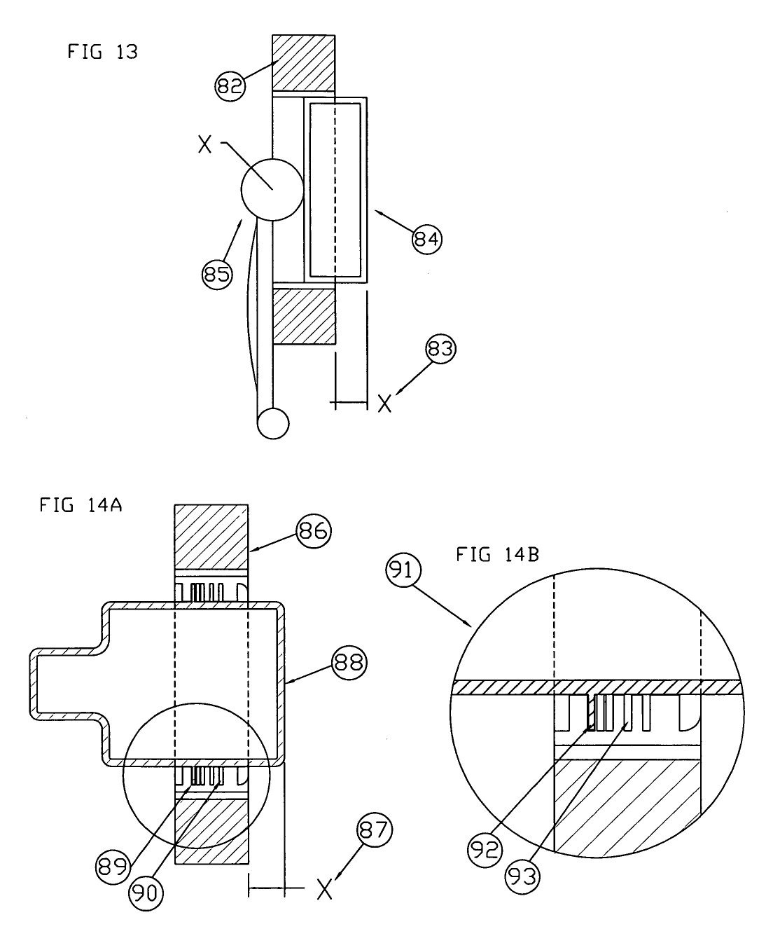

Another possible mechanism that can dispense tape on a line of contact points as described above consists of a roll of tape (FIG. 13-82) held a specific, desired distance “X” (FIG. 13-83) from a surface as described above. The tape is mounted on a drum (FIG. 13-84), and the drum is pushed the desired distance by the radius “X” of a spherical applicator tool (FIG. 13-85) as described above.

Another possible mechanism that can dispense tape on a line of contact points as described above consists of a roll of tape (FIG. 14A-86) positioned a particular distance from a surface (FIG. 14A-87). The tape is mounted on a sleeve (FIG. 14A-89) containing gauged gaps at the center. The gaps correspond to teeth on a drum (FIG. 14A-90). An expanded view of these teeth and gaps is shown (FIG. 14B-91). The teeth (FIG. 14B-92) fit into the gaps (FIG. 14B-93) and correspond to the radii of spherical applicators as described above.

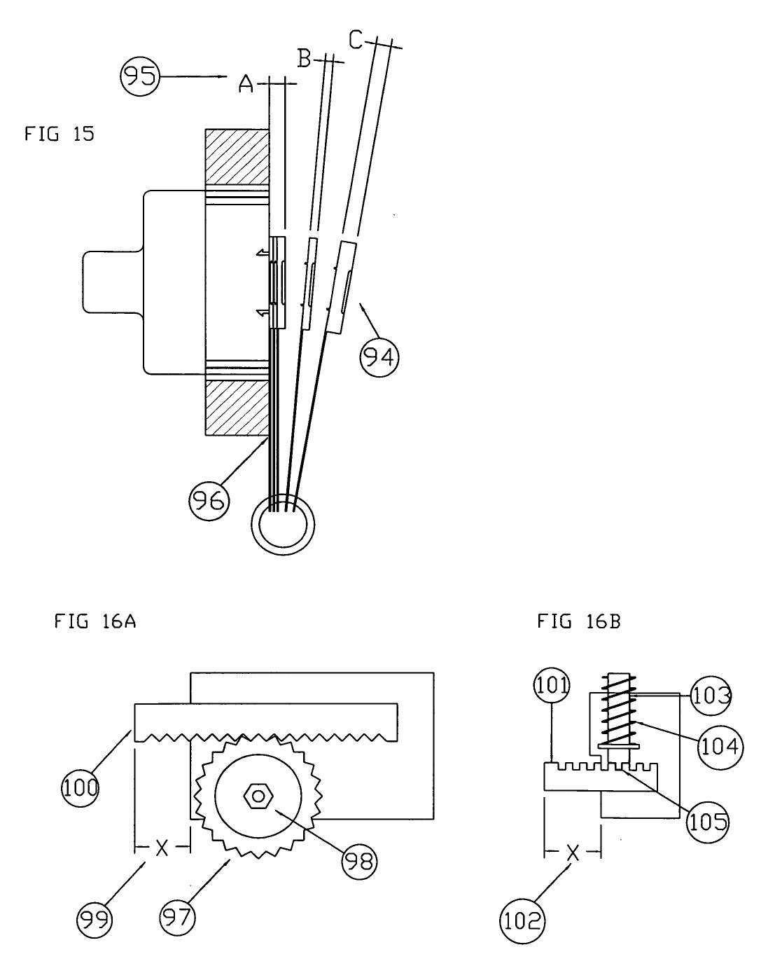

Another possible mechanism that can dispense tape on a line of contact points as described above consists of a roll of tape on a drum as described above (FIG. 15). The edge of a roll of tape (FIG. 15-94) can be positioned a desired distance (FIG. 15-95) from a surface as described above using shims (FIG. 15-96) that stack on the side of the tool towards the surface.

More gauging mechanisms that could be utilized in a mechanism that can dispense tape on a line of contact points as described above consists of a roll of tape as described above consist of a cogged wheel (FIG. 16A-97) held in place and tensioned by a nut (FIG. 16A-98). The cogged wheel controls a correlating toothed bar (FIG. 16A-99) that can hold a taping mechanism a particular distance (FIG. 16A-100) from a surface as described above. A similar mechanism utilizes a gauged bar (FIG. 16B-101) that can hold a taping mechanism a particular distance (FIG. 16B-102) from a surface as described above. A ram bar with a single spike on the end (FIG. 16B-103) is tensioned by a spring (FIG. 16B-104) and the spike meshes congruently (FIG. 16B-105) with the gaps on the gauged bar.

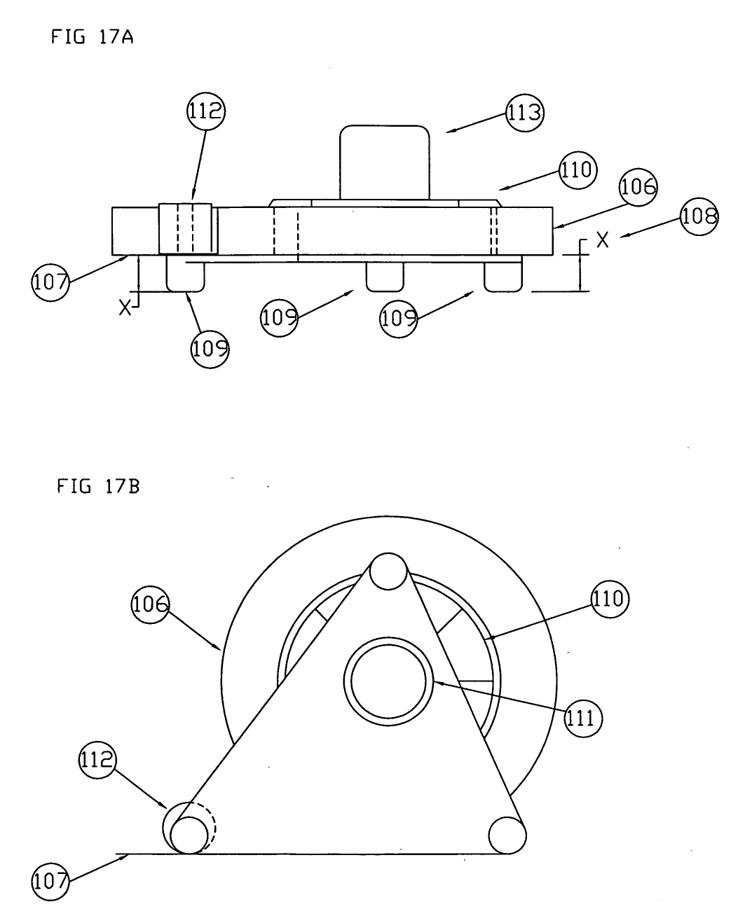

Yet another mechanism that can dispense tape on a line of contact points as described above is shown. A roll of tape (FIG. 17A-106), (FIG. 17B-106) and thus the edge of the roll of tape (FIG. 17A-107), (FIG. 17B-107) can be held a certain desired distance “X” (FIG. 17A-108) by gauged pegs of the same length “X” (FIG. 17A-109). The tape roll is held on a drum (FIG. 17A-110) that spins on an axel present on the body of the tool (FIG. 17b-111). The tape is pressed to the surface as described above by a smaller drum (FIG. 17A-112), (FIG. 17B-112). The entire tool can be held and manipulated by a handle (FIG. 17A-113).

I claim:

1. A method of forming and impacting a bead of caulking or similar material between two surfaces which are generally parallel along one axis, angle or edge or in a corner;
by forming the caulking with a set of tools that consists of one or a set of many balls of a specific radius used in combination with a relevantly gauged tape dispensing mechanism;
and that such tools are related and gauged so that the radius of a specific ball within the set establishes contact points a specific distance from the vertex of the corner while touching simultaneously upon both such surfaces, which establishes lines of “contact points” when the ball is moved parallel to them while touching them both;
and the “contact points” establish the desired locations and orientation for the tape or similar material to be applied with the gauged dispensing mechanism in order to form a boundary for such adhesive or caulking material a specific distance from the vertex of the corner, which is equal to the radius of the ball tool used; and the tape is utilized as a receptacle for excess caulking material that is displaced onto it after forming of said bead;
and that a multiplicity of such tools with various ball radii can exist as a set and be accompanied by a gauged tape dispensing mechanism or mechanisms that can dispense tape accurately on one or more parallel lines a particular distance from the vertex of said corner, and such a distance is dependent on and established by the size of the ball, its radius and the points at which it touches two such surfaces;
which stipulates a process of first determining a desired barrier or adhesion width or volume, then choosing the appropriate ball size with a radius relevant to the desired barrier, adhesion or caulking bead size, then applying the tape with a provided gauged dispenser relevant to the radius of the ball, then the application of the adhesion or caulking material as required, then the forming of such material by plowing the ball tool through the mass of roughly applied caulking while in contact with both surfaces that form the corner, then allowing the barrier adhesion or caulking material to cool or not or to dry or not to dry, then removing the tape or ribbon from the surfaces and thus removing any excess applied material;
and that the elements of the sets of tools provide a method of holding and manipulating them; and that the tools are formed from plastic, metal or other polymer sturdy material.

2. The invented method described in claim 1 is functional because of the relationship that exists between a ball of a specific radius and the contact points it creates when it simultaneously touches two surfaces that are generally parallel at least one axis, angle or edge or in a corner;
and when the ball is moved parallel to the real or projected intersection of such surfaces while touching them both, the contact points of the ball on the surfaces establish two lines on such surfaces parallel to and a specific distance from the real or projected intersection of such surfaces;
upon which the dispensing mechanism described in claim 1 that is gauged according to the radius of the ball used can locate and dispense tape or a ribbon as a barrier or boundary that prevents caulking or similar material from being applied to the surfaces beyond the contact points of such a ball;
and the tools created based on this relationship can be of various forms, yet all utilize a ball radius size and the contact points and lines it establishes on two such surfaces as the defining location for tape or similar materials to be dispensed as a form and receptacle for excess caulking material displaced after forming; and that excess caulking material will be displaced onto the tape as the ball is moved through the caulking material while touching both surfaces.

3. The invented method described in claim 1 creates the shape, volume and form of the applied barrier, adhesion or caulking material, which is formed and established by the shape of the space beneath and between the ball, its contact points on such surfaces as described in claim 1 and the real or projected intersection of such surfaces; and such shape, volume and form of a caulking bead finished this way can be of various sizes because the volume and form are dependent on the ball radius size, which can be changed to any radius size provided by choosing a different ball tool.
